(19) United States
(12) Patent Application Publication
(10) Pub. No.: US 2016/0179813 A1
(43) Pub. Date: Jun. 23, 2016

(54) METHOD AND SYSTEM FOR THEME MANAGEMENT

(71) Applicant: ZTE Corporation, Shenzhen (CN)

(72) Inventors: Zaiqiang SU, Shenzhen (CN); Jianxiu WANG, Shenzhen (CN); Sheng ZHONG, Shenzhen (CN)

(21) Appl. No.: 14/902,634

(22) PCT Filed: Dec. 16, 2013
(86) PCT No.: PCT/CN2013/089540

§ 371 Date: Jan. 4, 2016

(30) Foreign Application Priority Data
Jul. 2, 2013 (CN) 201310275025.8

(51) Int. Cl. G06F 17/30

(52) U.S. Cl. CPC G06F 17/3053; G06F 17/30554; G06F 17/30867

(57) ABSTRACT

Provided are a method and a system for theme management. According to the method, a client obtains a desktop theme, extracts characteristic value information of one or more comparative items from the desktop theme, then sends the characteristic value information of the one or more comparative items of the desktop theme to the theme management server; the theme management server calculates and obtains similarity degrees between a plurality of desktop themes and a pre-selected reference desktop theme by using a plurality of similarity-degree-calculation-dimensions; ranks the similarity degrees of the plurality of desktop themes; selects a pre-determined number of desktop themes whose similarity degrees are of top ranks and/or bottom ranks, and then sends the selected desktop themes to the client; the client displays to a user a list of desktop themes sent from the theme management server.

### TECHNICAL FIELD

The disclosure relates to the Mobile Terminal and computer technology field, and in particular, to a method and system for desktop theme management of tablet computer, mobile or other terminals.

### BACKGROUND

With the technological development of mobile communication, computer and internet, it has become a popularization for a user to customize a desktop theme on his/her computer or mobile phone. Taking 360 Security Desktop and Go Launcher as examples, a user may access official websites of these two software platforms to create his/her own favorable desktop theme and then install the created desktop theme in the phone to make the phone of the user more individualized and more visually adapted to the user's preference. At the same time, the user can share created themes with other people in a free or chargeable way by uploading the themes to the websites. However, a new problem arises when there are too many desktop themes for mobile equipment laying in internet. The problem lies in that, under such a circumstance, a user has to spend more time to search and chose the desktop themes he/she likes, thereby bringing complex operations and inconvenience to the user. So it is a problem demanding urgent solution to provide a solution to help users find out their favorite themes with high speed and efficiency.

### SUMMARY

The embodiments of the present solution provide a method and system of desktop theme management, so as to at least improve the efficiency of users in choosing desktop themes and increase product performance.

According to one aspect of the embodiments of the disclosure, a method for theme management is provided, including:

receiving from a client, at a theme management server, characteristic value information of one or more comparative items of a desktop theme;

obtaining, at a client, a desktop theme, and extracting characteristic value information of one or more comparative items from the desktop theme, then sending the characteristic value information of the one or more comparative items of the desktop theme to a theme management server;

calculating and obtaining, at the theme management server, similarity degrees between a plurality of desktop themes and a pre-selected reference desktop theme by using a plurality of similarity-degree-calculation-dimensions, wherein the similarity degrees are calculated based on the characteristic value information of the one or more comparative items of the desktop theme; ranking, at the theme management server, the similarity degrees of the plurality of desktop themes; selecting, at the theme management server, a pre-determined number of desktop themes whose similarity degrees are of top ranks and/or bottom ranks, and then sending the selected desktop themes to the client.

In an example embodiment, the step of calculating and obtaining, at the theme management server, the similarity degrees between the plurality of desktop themes and the pre-selected reference desktop theme by using the plurality of similarity-degree-calculation-dimensions, wherein the similarity degrees are calculated based on the characteristic value information of the one or more comparative items of the desktop theme, includes:

calculating and obtaining, at the theme management server, the similarity degrees between respective comparative items of the plurality of desktop themes and the one or more comparative items of the pre-selected reference desktop theme based on the characteristic value information of the one or more comparative items of the desktop theme and by using a color-similarity degree-calculation-dimension and a shape-similarity degree-calculation-dimension;

normalizing the similarity degrees for the respective comparative items to obtain the similarity degrees of the plurality of desktop themes; and

storing the similarity degrees of the plurality of desktop themes in a similarity degree list.

In an example embodiment, the one or more comparative items at least include one item selected from a group consisting of desktop background, main menu background, navigation bar background, a shape of an indication strip and a shape of a home button.

In an example embodiment, the steps of ranking, at the theme management server, the similarity degrees of the plurality of desktop themes, selecting, at the theme management server, the pre-determined number of desktop themes whose similarity degrees are of top ranks, and then sending the selected desktop themes to the client include:

ranking the similarity degrees of the plurality of desktop themes from a maximum value to a minimum value to obtain a ranking list;

selecting a pre-determined number of desktop themes of top similarity degree ranks from the ranking list; and

scanning the pre-determined number of desktop themes, putting desktop themes whose similarity degrees have values larger than a pre-set value into a first theme collection and sending the first theme collection to the client.

In an example embodiment, the steps of ranking, at the theme management server, the similarity degrees of the plurality of desktop themes, selecting, at the theme management server, the pre-determined number of desktop themes whose similarity degrees are of bottom ranks, and then sending the selected desktop themes to the client include:

ranking the similarity degrees of the plurality of desktop themes from a maximum value to a minimum value to obtain a ranking list;

selecting a pre-determined number of desktop themes of bottom similarity degree ranks from the ranking list; and

scanning the pre-determined number of desktop themes, putting desktop themes whose similarity degrees have values smaller than a pre-set value into a second theme collection and sending the second theme collection to the client.

According to another aspect of the embodiments of the disclosure, a method for theme management is provided, including:

obtaining, at a client, a desktop theme, and extracting characteristic value information of one or more comparative items from the desktop theme, then sending the characteristic value information of the one or more comparative items of the desktop theme to a theme management server;

displaying to a user, at the client, a list of desktop themes sent from the theme management server; wherein the desktop themes are selected by the theme management server and sent from the theme management server in a following manner: calculating and obtaining, at the theme management server, similarity degrees between a plurality of desktop themes and a pre-selected reference desktop theme by using a plurality of similarity-degree-calculation-dimensions, wherein the similarity degrees are calculated based on the characteristic value information of the one or more comparative items of the desktop theme; ranking, at the theme management server, the similarity degrees of the plurality of desktop themes; selecting, at the theme management server, a pre-determined number of desktop themes whose similarity degrees are of top ranks and/or bottom ranks, and then sending the selected desktop themes to the client.

According to still another aspect of the embodiments of the disclosure, a system for theme management is provided, including: a client and a theme management server, wherein:

the client is configured to obtain a desktop theme, extract characteristic value information of one or more comparative items from the desktop theme, then send the characteristic value information of the one or more comparative items of the desktop theme to the theme management server;

the theme management server is configured to calculate and obtain similarity degrees between a plurality of desktop themes and a pre-selected reference desktop theme by using a plurality of similarity-degree-calculation-dimensions, wherein the similarity degrees are calculated based on the characteristic value information of the one or more comparative items of the desktop theme; rank the similarity degrees of the plurality of desktop themes; select a pre-determined number of desktop themes whose similarity degrees are of top ranks and/or bottom ranks, and then send the selected desktop themes to the client;

the client is also configured to display to a user a list of desktop themes sent from the theme management server.

In an example embodiment, the theme management server is further configured to: calculate and obtain the similarity degrees between respective comparative items of the plurality of desktop themes and the one or more comparative items of the pre-selected reference desktop theme based on the characteristic value information of the one or more comparative items of the desktop theme and by using a color-similarity degree-calculation-dimension and a shape-similarity degree-calculation-dimension; normalize the similarity degrees for the respective comparative items to obtain the similarity degrees of the plurality of desktop themes; and store the similarity degrees of the plurality of desktop themes in a similarity degree list.

In an example embodiment, the one or more comparative items at least include one item selected from a group consisting of desktop background, main menu background, navigation bar background, a shape of an indication strip and a shape of a home button.

In an example embodiment, the theme management server is further configured to: rank the similarity degrees of the plurality of desktop themes from a maximum value to a minimum value to obtain a ranking list; select a pre-determined number of desktop themes of top similarity degree ranks from the ranking list; scan the pre-determined number of desktop themes; put desktop themes whose similarity degrees have values larger than a pre-set value into a first theme collection; and send the first theme collection to the client.

In an example embodiment, the theme management server is further configured to: rank the similarity degrees of the plurality of desktop themes from a maximum value to a minimum value to obtain a ranking list; select a pre-determined number of desktop themes of bottom similarity degree ranks from the ranking list; scan the pre-determined number of desktop themes; putting desktop themes whose similarity degrees have values smaller than a pre-set value into a second theme collection; and send the second theme collection to the client.

According to various aspects of the embodiments of the disclosure, a method and system for theme management based on similarity calculation theory is provided. The solution can calculate, for an individual user, the themes most similar to the one used by the user for a long term and send them to the user. At the same time, some themes quite different from the theme that the user likes can be recommended for the user to try and experience. The technical solution improves the efficiency of choosing desktop themes, meets users' demands and increases product performance.

### BRIEF DESCRIPTION OF THE DRAWINGS

FIG. 1 is a schematic diagram of the flow of a method for theme management according to an embodiment of the present solution;

FIG. 2 is a schematic diagram of the flow of an example embodiment of the present solution;

FIG. 3 is a structural schematic diagram of a system for theme management according to an embodiment of the present solution.

The description on the technical solution of the present disclosure would be made in detail in combination with the drawings for clarity.

### DETAILED DESCRIPTION OF THE EMBODIMENTS

It should be understood that the embodiments described herein are just to illustrate and explain, rather than limit the disclosure.

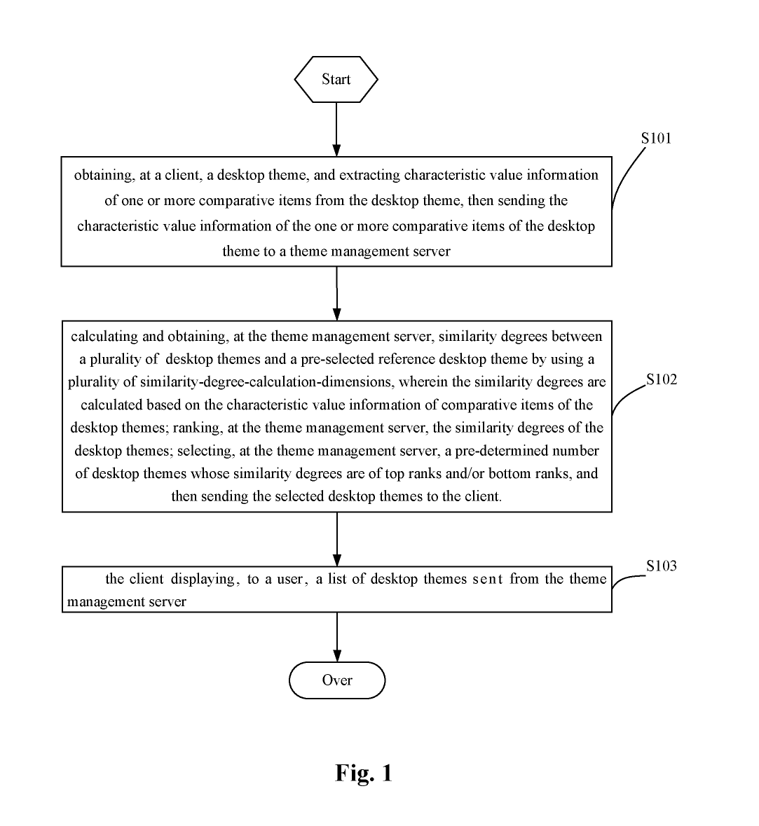

As shown in FIG. 1, a method for theme management is provided by an embodiment of the present solution, including steps S101 to S103.

In step S101, a desktop theme is obtained at a client, and characteristic value information of one or more comparative items from the desktop theme is extracted, then the characteristic value information of the one or more comparative items of the desktop theme is sent to a theme management server.

In this embodiment, the client may be an operation platform provided to the user by mobile terminals such as mobile phones or tablet computers. The ways in which the client acquires the desktop theme may include acquiring from local mobile terminals or acquiring from web servers, such as acquiring 360 security desktop from 360 official website.

When operating, the user may start a management tool of the desktop theme of his/her mobile terminal, and enter the theme tool interface.

After the desktop theme Client acquires the desk theme, the Client analyzes the present desktop theme, extracts characteristic value information of one or more comparative items from the desktop theme, then sends the characteristic value information of the one or more comparative items of the desktop theme to the theme management server. The theme management server performs similarity calculation.

In this embodiment, the technical solution is specifically related to characteristic values of five comparative items, which are desktop background, main menu background, navigation bar background, a shape of an indication strip and a shape of a home button. Of course, the comparative items of the desktop theme are not limited to the above five items. The comparative items may also be any item or items of the above five items.

The characteristic value of the comparative item may be a color sampled value or shape sampled value of a certain picture. Alternatively, the characteristic value of the comparative item may be an identification number (Id) of the picture rather than the color or shape sampled value of the certain picture. The theme management server will record the picture information used by every desktop theme. As the calculating ability of the theme management server is much more powerful than the Client, the work needing a large amount of calculation is completed by the theme management server.

In Step S102, similarity degrees between a plurality of desktop themes and a pre-selected reference desktop theme are calculated and obtained at the theme management server by using a plurality of similarity-degree-calculation-dimensions, wherein the similarity degrees are calculated based on the characteristic value information of the one or more comparative items of the desktop theme; the similarity degrees of the plurality of desktop themes are ranked at the theme management server; a pre-determined number of desktop themes whose similarity degrees are of top ranks and/or bottom ranks are selected at the theme management server, and then the selected desktop themes are sent to the client.

In Step S103, the client displays, to a user, a list of desktop themes sent from the theme management server.

In this embodiment, the theme management server realizes the theme management based on the theory of the theme similarity calculation. By this calculation, the themes quite similar to or very different from the theme frequently used by the user can be found, and then sent to the user as themes the user might like or themes that might be fresh to the user.

The present Windows operation system has two built-in themes, which are respectively a classical one and a XP theme. The two themes are mainly distinguished from each other by the color backgrounds of the navigation bar and some public controls. In contrast, this embodiment adds the factors of frequently-used icon shapes and focuses on recommending themes suitable for a single user.

In an example embodiment, the theme management server calculates and obtains the similarity degrees between respective comparative items of the plurality of desktop themes and the one or more comparative items of the pre-selected reference desktop theme based on the characteristic value information of the one or more comparative items of the desktop theme and by using a color-similarity degree-calculation-dimension and a shape-similarity degree-calculation-dimension; the similarity degrees for the respective comparative items are normalized to obtain the similarity degrees of the plurality of desktop themes; and the similarity degrees of the plurality of desktop themes are stored in a similarity degree list.

In the above embodiments, the pre-selected reference theme may be a desktop theme used by the user for a long term or a desktop theme often used by the user.

The computing formula of similarity is a color-similarity degree-calculation-dimension of some themes+a shape-similarity degree-calculation-dimension of some thematic icons.

In practical operation, the technical solution may be implemented based on the desktop application of a mobile terminal which can switch the themes freely. First, the similarity between independent comparative items and the pre-selected reference desktop theme is calculated by using the mature computing formulas of color similarity and shape similarity, and then the calculated similarity is solidified. The main purpose of solidifying is to facilitate the analysis in the future and save server's resources by avoiding repetitive similarity calculation for a same theme.

Then the theme management server normalizes the similarity degrees for the respective comparative items. The normalization contains following steps: assigning different weights to five comparative items, mapping the similarity of the themes into a section of [0,1] to obtain the value of theme similarity within the section of [0,1], which serves as a reference for selecting themes, then storing and solidifying the result in the similarity list.

At the same time, considering the intense contrast themes, they may be recommended to the user in another way, such as making the users experience a fresh theme. At present, users pursue for personality as well as freshness. It is possible that some users would like to try some intense contrast themes after using a similar type of theme for a long time. In this case, it will be useful to promote products when the terminal theme management tool satisfies the users' pursue for freshness.

In the above mentioned example embodiment, the major difference between different themes in terms of interaction lies in the color and icon shape of the picture. While in the present example embodiment, in desktop themes for Mifavor mobile phones, the differences among the themes are following comparative items: desktop background, main menu background, navigation bar background, a shape of an indication strip and a shape of a home button. First, independent similarity value for each of the five comparative items of the theme can be designed respectively, then different weights are assigned to the similarity degrees for the five comparative items and then the similarity degrees for the five comparative items are normalized to obtain the similarity of themes. After being normalized, the value of theme similarity is within the section of [0, 1]. The larger this value is, the more similar the theme is. The smaller this value is, the more distinguishing the theme is.

The calculation method of color similarity and shape similarity are not elaborated here. Briefly, there are some very mature calculation methods for color similarity, such as some method based on histogram color similarity calculation or HSV color similarity calculation. There are also some very mature calculation methods for shape similarity, such as calculation methods of shape similarity based on structure moment invariants, H-EMD-based shape matching by shape context, and process planning by case-based reasoning. At present, the shape similarity calculation method is widely applied to face recognition, garden design, engineering industry and so on.

After similarity of the themes is calculated based on the above method, the similarity degrees of the plurality of desktop themes are ranked; and a pre-determined number of desktop themes whose similarity degrees are of top ranks are selected and then sent to the client.

Specifically, as an example implementation, the similarity degrees of the plurality of desktop themes may be first ranked from a maximum value to a minimum value to obtain a ranking list; a pre-determined number of desktop themes of top similarity degree ranks may be then selected from the ranking list; the pre-determined number of desktop themes are scanned, and desktop themes whose similarity degrees have values larger than a pre-set value (such as 0.8) are put into a first theme collection.

Considering some intense contrast themes, another method may be chosen: the similarity degrees of the plurality of desktop themes are ranked from a maximum value to a minimum value to obtain a ranking list; a pre-determined number of desktop themes of bottom similarity degree ranks may be selected from the ranking list; and the pre-determined number of desktop themes are scanned, desktop themes whose similarity degrees have values smaller than a pre-set value (such as 0.3) are put into a second theme collection.

Then the first theme collection and the second theme collection are sent to the client. The client shows the two lists of desktop themes sent from the theme management server to the user.

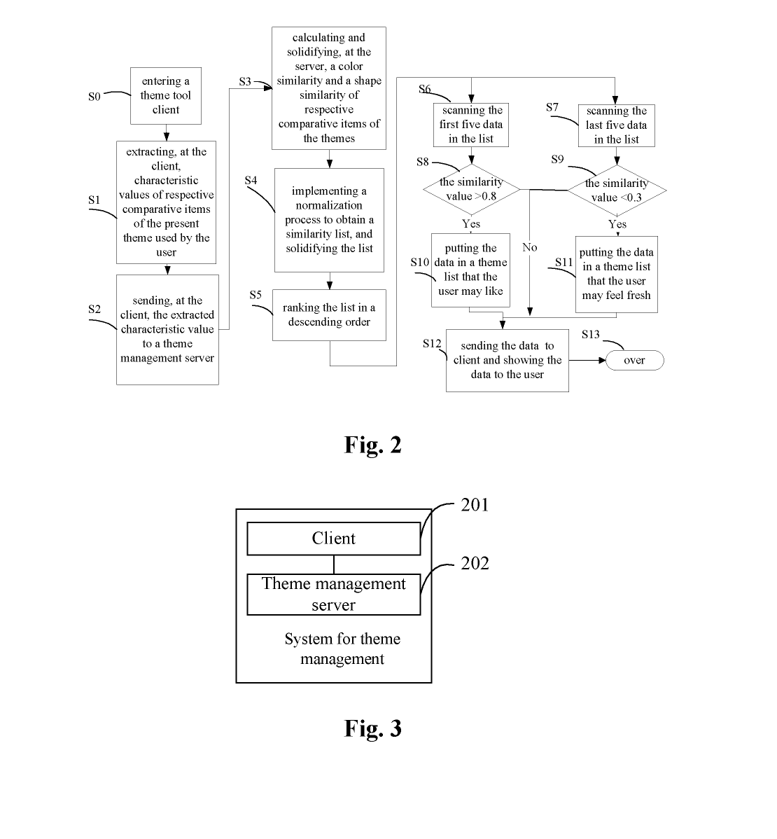

As shown in FIG. 2, the technical solution of the embodiment is elaborated in detail taking a Mifavor desktop theme application as an example. The technical solution includes the following steps S0 to S13.

In step S0, a user starts a management tool for desktop theme, and enters a theme tool interface.

In step S1, the desktop theme application client starts to analyze the theme that user uses currently, and extract characteristic values of five comparative items of the theme (desktop background, main menu background, navigation bar background, a shape of an indication strip and a shape of a home button). It should be noted that characteristic value mentioned above may also be an ID number of the picture rather than color or shape sampled value of a certain picture. Because the server has records of picture information of every used desktop theme, and the calculating ability of the theme management server is much more powerful than the Client, the work needing a large amount of calculation is completed by the theme management server.

In step S2, the client sends the theme characteristic value information extracted in step Si to the theme management server, and all calculation for similarity will be completed at the theme management server.

In step S3, the theme management server calculates and solidifies a color similarity and a shape similarity of respective theme comparative items. The comparative items here are the above-mentioned five items. The main purpose of solidifying is to facilitate the analysis in the future and save server's resources by avoiding repetitive similarity calculation for a same theme.

In step S4, the result obtained by step S3 is normalized. The method of normalizing is to assign different weights to the five comparative items, map the similarity of the themes into a section of [0, 1], and then store and solidify the result into a similarity list.

In step S5, the similarity list obtained by step S4 is ranked in a descending order to obtain a similarity list ranking from a max value to a minimum value. The first five values are selected from the ranked list and input into the process of step S6, and the last five values are selected from the ranked list and input into the process of step S7.

In step S6, the five data provided by step S5 are scanned, and then step S8 is executed.

In step S7, the five data provided by step S5 are scanned, and then step S9 is executed.

In step S8, it is judged whether the similarity value is larger than 0.8. If the similarity value is larger than 0.8, it represents that the current theme is quite similar to the one used by the user, then step S10 is executed. If the similarity value is smaller than or equal to 0.8, it represents that there's no value larger than 0.8, then the scanning of the collection can be stopped and step S12 is executed.

In step S9, it is judged whether the similarity value is smaller than 0.3. If the similarity value is smaller than 0.3, it represents that the theme is intense contrast to the user's favorite one, then step S11 is executed. If the similarity value is larger than or equal to 0.3, it represents that there's no value smaller than 0.3, then the scanning of the collection can be stopped and step S12 is executed.

In step S10, the data is put in the theme collection that the user may prefer and recommended to the user as themes that the user would probably like.

In step S11, the data is put in the theme collection that the user may feel fresh and recommended to the user as fresh themes.

In step S12, the two collections obtained by step S10 and step S11 are sent back to the client. The client will show the user two theme lists of different styles according to the received collections. After this step is completed, the flow ends at step S13.

In step S13, the flow ends. Supposing that green background and round icon theme is used by user A for a long time, this embodiment will provide the user with two recommended theme lists of different styles. One theme list contains some themes with a color quite similar to green and provided with icons of a round or elliptic shape, and the user may choose one from the list as his/her new theme. The other theme list contains some theme quite different from the often used one. For example, the color of themes maybe black, white, red and so on. The shape of icons maybe square, triangle and so on. Since these themes are not in accordance with the user's habit, the user may not like them. However, if the user occasionally wants to experience a fresh theme, the scheme will meet the user's requirement.

Of course, the two styles of themes may be recommended to the user independently, as well as at the same time.

According to the embodiments of the disclosure, the solution can calculate, for an individual user, the themes most similar to the one used by the user for a long term based on similarity calculation theory and send them to the user. At the same time, some themes quite different from the theme that the user likes can be recommended for the user to try and experience. The technical solution improves the efficiency of choosing desktop themes, meets users' demands and increases product performance.

As shown in FIG. 3, a system for theme management is provided by an embodiment of the present solution. The system includes: a client 201 and a theme management server 202.

The client 201 is configured to acquire a desktop theme, extract characteristic values of one or more comparative items from the theme, then send the characteristic values of the one or more comparative items of the desktop theme to the theme management server 202.

The theme management sever 202 is configured to calculate and obtain similarity degrees between a plurality of desktop themes and a pre-selected reference desktop theme by using a plurality of similarity-degree-calculation-dimensions, wherein the similarity degrees are calculated based on the characteristic value information of the one or more comparative items of the desktop theme; rank the similarity degrees of the plurality of desktop themes; select a pre-determined number of desktop themes whose similarity degrees are of top ranks and/or bottom ranks, and then send the selected desktop themes to the client 201.

The client 201 is also configured to display the list of desktop themes sent from the theme management server 202 to the user.

In the embodiment, the client 201 may be an operation platform provided to the user by mobile terminals such as mobile phones or tablet computers. The ways in which the client 201 acquires the desktop theme may include acquiring from local mobile terminals or acquiring from web servers, such as acquiring 360 security desktop from 360 official website.

When operating, the user may start a management tool of the desktop theme of his/her mobile terminal, and enter the theme tool interface.

After the desktop theme client 201 acquires the desk theme, the Client analyzes the present desktop theme, extracts some characteristic values of the one or more comparative items from the desktop theme, then sends the characteristic values of the one or more comparative items of the desktop theme to the theme management server 202. The theme management server 202 performs similarity calculation.

In this embodiment, the technical solution is specifically related to characteristic values of five comparative items, which are desktop background, main menu background, navigation bar background, a shape of an indication strip and a shape of a home button. Of course, the comparative items of the desktop themes are not limited to the above five items. The comparative items may also be any item or items of the above five items.

The characteristic value of the comparative item may be a color sampled value or shape sampled value of a certain picture. Alternatively, the characteristic value of the comparative item may be an Id number of the picture rather than the color or shape sampled value of the certain picture. The theme management server 202 will record the picture information used by every desktop theme. As the calculating ability of the theme management server 202 is much more powerful than the Client, the work needing a large amount of calculation is completed by the theme management server 202.

In this embodiment, the theme management server 202 realizes the theme management based on the theory of the theme similarity calculation. By this calculation, the themes quite similar to or very different from the theme frequently used by the user can be found, and then sent to the user as themes the user might like or themes that might be fresh to the user.

The present Windows operation system has two built-in themes, which are respectively a classical one and a XP theme. The two themes are mainly distinguished from each other by the color backgrounds of the navigation bar and some public controls. In contrast, this embodiment adds the factors of frequently-used icon shapes and focuses on recommending themes suitable for a single user.

In an example embodiment, the theme management server 202 calculates and acquires, according to the characteristic values of the comparative items of the desktop themes, the similarity degrees between the respective comparative items of the desktop themes and the one or more comparative items of the pre-selected reference desktop theme by using color and shape similarity calculation dimensions; normalizes the similarity degrees for the respective comparative items to obtain the similarity degrees of the desktop themes; stores the similarity degrees of desktop themes in a similarity degree list.

In the above embodiments, the pre-selected reference themes may be a desktop theme used by the user for a long term or a desktop theme often used by the user.

The computing formula of similarity is a color-similarity degree-calculation-dimension of some themes+a shape-similarity degree-calculation-dimension of some thematic icons.

In practical operation, the technical solution may be implemented based on the desktop application of a mobile terminal which can switch the themes freely. First, the similarity between independent comparative items and the pre-selected reference desktop theme is calculated by using the mature computing formulas of color similarity and shape similarity, and then the calculated similarity is solidified. The main purpose of solidifying is to facilitate the analysis in the future and save server's resources by avoiding repetitive similarity calculation for a same theme.

Then the theme management server normalizes the similarity degrees for the respective comparative items. The normalization contains following steps: assigning different weights to five comparative items, mapping the similarity of the themes into a section of [0,1] to obtain the value of theme similarity within the section of [0,1], which serves as a reference for selecting themes, then storing and solidifying the result in the similarity list.

At the same time, considering the intense contrast themes, they may be recommended to the user in another way, such as making the users experience a fresh theme. At present, users pursue for personality as well as freshness. It is possible that some users would like to try some intense contrast themes after using a similar type of theme for a long time. In this case, it will be useful to promote products when the terminal theme management tool satisfies the users' pursue for freshness.

In the above mentioned example embodiment, the major difference between different themes in terms of interaction lies in the color and icon shape of the picture. While in the present example embodiment, in desktop themes for Mifavor mobile phones, the differences among the themes are following comparative items: desktop background, main menu background, navigation bar background, a shape of an indication strip and a shape of a home button. First, independent similarity value for each of the five comparative items of the theme can be designed respectively, then different weights are assigned to the similarity degrees for the five comparative items and then the similarity degrees for the five comparative items are normalized to obtain the similarity of themes. After being normalized, the value of theme similarity is within the section of [0, 1]. The larger this value is, the more similar the theme is. The smaller this value is, the more distinguishing the theme is.

The calculation method of color similarity and shape similarity are not elaborated here. Briefly, there are some very mature calculation methods for color similarity, such as some method based on histogram color similarity calculation or HSV color similarity calculation. There are also some very mature calculation methods for shape similarity, such as calculation methods of shape similarity based on structure moment invariants, H-EMD-based shape matching by shape context, and process planning by case-based reasoning. At present, the shape similarity calculation method is widely applied to face recognition, garden design, engineering industry and so on.

After similarity of the themes is calculated based on the above method, the similarity degrees of the desktop themes are ranked, and a pre-determined number of themes whose similarity degrees are of top ranks are selected and then sent to the client 201.

Specifically, as an example implementation, the similarity degrees of the plurality of desktop themes may be first ranked from a maximum value to a minimum value to obtain a ranking list; a pre-determined number of desktop themes of top similarity degree ranks may be then selected from the ranking list; the pre-determined number of desktop themes are scanned, and desktop themes whose similarity degrees have values larger than a pre-set value (such as 0.8) are put into a first theme collection.

Considering some intense contrast themes, another method may be chosen:

the similarity degrees of the plurality of desktop themes are ranked from a maximum value to a minimum value to obtain a ranking list; a pre-determined number of desktop themes of bottom similarity degree ranks may be selected from the ranking list; and the pre-determined number of desktop themes are scanned, desktop themes whose similarity degrees have values smaller than a pre-set value (such as 0.3) are put into a second theme collection.

Then the first theme collection and the second theme collection are sent to the client 201. The client 201 shows the two lists of desktop themes sent from the theme management server 202 to the user.

According to aspects of the embodiments of the disclosure, a method and a system for theme management based on similarity calculation theory are provided. The solution can calculate, for an individual user, the themes most similar to the one used by the user for a long term and send them to the user. At the same time, some themes quite different from the theme that the user likes can be recommended for the user to try and experience. The technical solution improves the efficiency of choosing desktop themes, meets users' demands and increases product performance.

### INDUSTRIAL APPLICABILITY

The solutions provided by the embodiments of the disclosure can be applied to the Mobile Terminal and computer technology field, and are provided based on similarity calculation theory. The solution can calculate, for an individual user, the themes most similar to the one used by the user for a long term and send them to the user. At the same time, some themes quite different from the theme that the user likes can be recommended for the user to try and experience. The technical solution improves the efficiency of choosing desktop themes, meets users' demands and increases product performance.

1. A method for theme management, comprising:
receiving from a client, at a theme management server, characteristic value information of one or more comparative items of a pre-selected reference desktop theme;
calculating to obtain, at the theme management server, similarity degrees between a plurality of desktop themes and the pre-selected reference desktop theme by using a plurality of similarity-degree-calculation-dimensions, wherein the similarity degrees are calculated based on the characteristic value information of the one or more comparative items of the desktop theme; ranking, at the theme management server, the similarity degrees of the plurality of desktop themes; selecting, at the theme management server, a pre-determined number of desktop themes whose similarity degrees are of top ranks and/or bottom ranks, and then sending the selected desktop themes to the client.

2. The method as claimed in claim 1, wherein the step of calculating to obtain, at the theme management server, the similarity degrees between the plurality of desktop themes and the pre-selected reference desktop theme by using the plurality of similarity-degree-calculation-dimensions, wherein the similarity degrees are calculated based on the characteristic value information of the one or more comparative items of the pre-selected reference desktop theme, comprises:
calculating to obtain, at the theme management server, the similarity degrees between respective comparative items of the plurality of desktop themes and the one or more comparative items of the pre-selected reference desktop theme based on the characteristic value information of the one or more comparative items of the pre-selected reference desktop theme and by using a color-similarity degree-calculation-dimension and a shape-similarity degree-calculation-dimension;
normalizing the similarity degrees for the respective comparative items to obtain the similarity degrees of the plurality of desktop themes; and
storing the similarity degrees of the plurality of desktop themes in a similarity degree list.

3. The method as claimed in claim 1, wherein the one or more comparative items at least comprise one item selected from a group consisting of desktop background, main menu background, navigation bar background, a shape of an indication strip and a shape of a home button.

4. The method as claimed in claim 1, wherein steps of ranking, at the theme management server, the similarity degrees of the plurality of desktop themes, selecting, at the theme management server, the pre-determined number of desktop themes whose similarity degrees are of top ranks, and then sending the selected desktop themes to the client comprise:
ranking the similarity degrees of the plurality of desktop themes from a maximum value to a minimum value to obtain a ranking list;
selecting a pre-determined number of desktop themes of top similarity degree ranks from the ranking list; and
scanning the pre-determined number of desktop themes, putting desktop themes whose similarity degrees have values larger than a pre-set value into a first theme collection and sending the first theme collection to the client.

5. The method as claimed in claim 1, wherein steps of ranking, at the theme management server, the similarity degrees of the plurality of desktop themes, selecting, at the theme management server, the pre-determined number of desktop themes whose similarity degrees are of bottom ranks, and then sending the selected desktop themes to the client comprise:
ranking the similarity degrees of the plurality of desktop themes from a maximum value to a minimum value to obtain a ranking list;
selecting a pre-determined number of desktop themes of bottom similarity degree ranks from the ranking list; and
scanning the pre-determined number of desktop themes, putting desktop themes whose similarity degrees have values smaller than a pre-set value into a second theme collection and sending the second theme collection to the client.

6. A method for theme management, comprising:
obtaining, at a client, a pre-selected reference desktop theme, and extracting characteristic value information of one or more comparative items from the pre-selected reference desktop theme, then sending the characteristic value information of the one or more comparative items of the pre-selected reference desktop theme to a theme management server;
displaying to a user, at the client, a list of desktop themes sent from the theme management server; wherein the desktop themes are selected by the theme management server and sent from the theme management server in a following manner: calculating to obtain, at the theme management server, similarity degrees between a plurality of desktop themes and the pre-selected reference desktop theme by using a plurality of similarity-degree-calculation-dimensions, wherein the similarity degrees are calculated based on the characteristic value information of the one or more comparative items of the pre-selected reference desktop theme; ranking, at the theme management server, the similarity degrees of the plurality of desktop themes; selecting, at the theme management server, a pre-determined number of desktop themes whose similarity degrees are of top ranks and/or bottom ranks, and then sending the selected desktop themes to the client.

7. A system for theme management, comprising: a client and a theme management server, wherein:
the client is configured to obtain a pre-selected reference desktop theme, extract characteristic value information of one or more comparative items from the pre-selected reference desktop theme, then send the characteristic value information of the one or more comparative items of the pre-selected reference desktop theme to the theme management server;
the theme management server is configured to calculate to obtain similarity degrees between a plurality of desktop themes and the pre-selected reference desktop theme by using a plurality of similarity-degree-calculation-dimensions, wherein the similarity degrees are calculated based on the characteristic value information of the one or more comparative items of the pre-selected reference desktop theme; rank the similarity degrees of the plurality of desktop themes; select a pre-determined number of desktop themes whose similarity degrees are of top ranks and/or bottom ranks, and then send the selected desktop themes to the client;
the client is also configured to display to a user a list of desktop themes sent from the theme management server.

8. The system as claimed in claim 7, wherein the theme management server is further configured to: calculate to obtain the similarity degrees between respective comparative items of the plurality of desktop themes and the one or more comparative items of the pre-selected reference desktop theme based on the characteristic value information of the one or more comparative items of the pre-selected reference desktop theme and by using a color-similarity degree-calculation-dimension and a shape-similarity degree-calculation-dimension; normalize the similarity degrees for the respective comparative items to obtain the similarity degrees of the plurality of desktop themes; and store the similarity degrees of the plurality of desktop themes in a similarity degree list.

9. The system as claimed in claim 7, wherein the one or more comparative items at least comprise one of the followings: desktop background, main menu background, navigation bar background, a shape of an indication strip and a shape of a home button.

10. The system as claimed in claim 7, wherein the theme management server is further configured to: rank the similarity degrees of the plurality of desktop themes from a maximum value to a minimum value to obtain a ranking list; select a pre-determined number of desktop themes of top similarity degree ranks from the ranking list; scan the pre-determined number of desktop themes; put desktop themes whose similarity degrees have values larger than a pre-set value into a first theme collection; and send the first theme collection to the client.

11. The system as claimed in claim 7, the theme management server is further configured to: rank the similarity degrees of the plurality of desktop themes from a maximum value to a minimum value to obtain a ranking list; select a pre-determined number of desktop themes of bottom similarity degree ranks from the ranking list; scan the pre-determined number of desktop themes; put desktop themes whose similarity degrees have values smaller than a pre-set value into a second theme collection; and send the second theme collection to the client.

12. The method as claimed in claim 2, wherein steps of ranking, at the theme management server, the similarity degrees of the plurality of desktop themes, selecting, at the theme management server, the pre-determined number of desktop themes whose similarity degrees are of top ranks, and then sending the selected desktop themes to the client comprise:
ranking the similarity degrees of the plurality of desktop themes from a maximum value to a minimum value to obtain a ranking list;
selecting a pre-determined number of desktop themes of top similarity degree ranks from the ranking list; and
scanning the pre-determined number of desktop themes, putting desktop themes whose similarity degrees have values larger than a pre-set value into a first theme collection and sending the first theme collection to the client.

13. The method as claimed in claim 3, wherein steps of ranking, at the theme management server, the similarity degrees of the plurality of desktop themes, selecting, at the theme management server, the pre-determined number of desktop themes whose similarity degrees are of top ranks, and then sending the selected desktop themes to the client comprise:
ranking the similarity degrees of the plurality of desktop themes from a maximum value to a minimum value to obtain a ranking list;
selecting a pre-determined number of desktop themes of top similarity degree ranks from the ranking list; and
scanning the pre-determined number of desktop themes, putting desktop themes whose similarity degrees have values larger than a pre-set value into a first theme collection and sending the first theme collection to the client.

14. The method as claimed in claim 2, wherein steps of ranking, at the theme management server, the similarity degrees of the plurality of desktop themes, selecting, at the theme management server, the pre-determined number of desktop themes whose similarity degrees are of bottom ranks, and then sending the selected desktop themes to the client comprise:
ranking the similarity degrees of the plurality of desktop themes from a maximum value to a minimum value to obtain a ranking list;
selecting a pre-determined number of desktop themes of bottom similarity degree ranks from the ranking list; and
scanning the pre-determined number of desktop themes, putting desktop themes whose similarity degrees have values smaller than a pre-set value into a second theme collection and sending the second theme collection to the client.

15. The method as claimed in claim 3, wherein steps of ranking, at the theme management server, the similarity degrees of the plurality of desktop themes, selecting, at the theme management server, the pre-determined number of desktop themes whose similarity degrees are of bottom ranks, and then sending the selected desktop themes to the client comprise:
ranking the similarity degrees of the plurality of desktop themes from a maximum value to a minimum value to obtain a ranking list;
selecting a pre-determined number of desktop themes of bottom similarity degree ranks from the ranking list; and
scanning the pre-determined number of desktop themes, putting desktop themes whose similarity degrees have values smaller than a pre-set value into a second theme collection and sending the second theme collection to the client.

16. The system as claimed in claim 8, wherein the theme management server is further configured to: rank the similarity degrees of the plurality of desktop themes from a maximum value to a minimum value to obtain a ranking list; select a pre-determined number of desktop themes of top similarity degree ranks from the ranking list; scan the pre-determined number of desktop themes; put desktop themes whose similarity degrees have values larger than a pre-set value into a first theme collection; and send the first theme collection to the client.

17. The system as claimed in claim 9, wherein the theme management server is further configured to: rank the similarity degrees of the plurality of desktop themes from a maximum value to a minimum value to obtain a ranking list; select a pre-determined number of desktop themes of top similarity degree ranks from the ranking list; scan the pre-determined number of desktop themes; put desktop themes whose similarity degrees have values larger than a pre-set value into a first theme collection; and send the first theme collection to the client.

18. The system as claimed in claim 8, the theme management server is further configured to: rank the similarity degrees of the plurality of desktop themes from a maximum value to a minimum value to obtain a ranking list; select a pre-determined number of desktop themes of bottom similarity degree ranks from the ranking list; scan the pre-determined number of desktop themes; put desktop themes whose similarity degrees have values smaller than a pre-set value into a second theme collection; and send the second theme collection to the client.

19. The system as claimed in claim 9, the theme management server is further configured to: rank the similarity degrees of the plurality of desktop themes from a maximum value to a minimum value to obtain a ranking list; select a pre-determined number of desktop themes of bottom similarity degree ranks from the ranking list; scan the pre-determined number of desktop themes; put desktop themes whose similarity degrees have values smaller than a pre-set value into a second theme collection; and send the second theme collection to the client.
